(19) United States
(12) Patent Application Publication
(10) Pub. No.: US 2014/0269645 A1
(43) Pub. Date: Sep. 18, 2014

(54) WIRELESS ACCESS POINT SYNCHRONIZATION

(71) Applicant: QUALCOMM Incorporated, San Diego, CA (US)

(72) Inventor: Ju-Yong Do, Palo Alto, CA (US)

(73) Assignee: QUALCOMM Incorporated, San Diego, CA (US)

(21) Appl. No.: 13/802,403

(22) Filed: Mar. 13, 2013

(51) Int. Cl. G01S 5/02

(52) U.S. Cl. CPC G01S 5/021
USPC 370/338

(57) ABSTRACT

Examples disclosed herein may relate to wireless access point synchronization for use in mobile device position estimation. In an aspect, one-way synchronization packets may be exchanged among neighboring access points, and individual access points may adjust a local dock based at least in part on time reference indicators received in synchronization packets.

### BACKGROUND

1. Field

Subject matter disclosed herein relates to wireless access point synchronization for use in mobile device position estimation.

2. Information

The position of a mobile device, such as a cellular telephone, may be estimated based on information gathered from various systems. One such system may comprise a wireless local access network (MAN) communication system comprising a number of access points to support communications for a number of mobile devices. A position estimate for a mobile device may be obtained, for example, through trilateration based on timing parameters such as round trip delay, code phase detections, signal strength estimates, and/or other measurements obtained through communication with one or more access points. A position estimate may be further based on known or reported locations of the access points.

### SUMMARY

In an aspect, a first one-way synchronization message comprising a first time reference indicator may be received at a first access point positioned at a first location from a second access point positioned at a second location. A time delay between a local time reference for the first access point and the first time reference indicator may be calculated, and the local time reference may be adjusted based at least in part on the computed time delay and based at least in part on a range between the first access point and the second access point. Also, in an aspect, a second one-way synchronization message comprising an indication of the adjusted local time reference may be transmitted to one or more access points, including the second access point.

In a further aspect, an article may comprise a storage medium having stored thereon instructions executable by a processor of a first access point positioned at a first location to obtain a first one-way synchronization message comprising a first time reference indicator from a second access point positioned at a second location. In another aspect, the storage medium may have stored therein further instructions executable by the processor to calculate a time delay between a local time reference for the first access point and the first time reference indicator, and to adjust the local time reference based at least in part on the computed time delay and based at least in part on a range between the first access point and the second access point. Also, in an aspect, the storage medium may have stored therein further instructions executable by the processor to initiate transmission of a second one-way synchronization message comprising an indication of the adjusted local time reference to one or more access points, including the second access point.

Additionally, in an aspect, an apparatus comprising a first access point positioned at a first location may comprise a communication interface to receive a first one-way synchronization message comprising a first time reference indicator from a second access point positioned at a second location. In another aspect, the apparatus may comprise a processor to calculate a time delay between a local time reference for the first access point and the first time reference indicator, and to adjust the local time reference based at least in part on the computed time delay and based at least in part on a range between the first access point and the second access point. Also, in an aspect, the communication interface may transmit a second one-way synchronization message comprising an indication of the adjusted local time reference to one or more access points, including the second access point.

### BRIEF DESCRIPTION OF THE FIGURES

Non-limiting and non-exhaustive examples will be described with reference to the following figures, wherein like reference numerals refer to like parts throughout the various figures.

FIG. 1 is a schematic block diagram depicting an example trilateration technique for determining an initial estimated position for a mobile device.

FIG. 2 is a schematic block diagram depicting an example floor plan including wireless access points.

FIG. 3 is a flow diagram of an example technique for mobile device position estimation.

FIG. 4a is a schematic block diagram depicting an example broadcast communication from an access point to one or more additional access points.

FIG. 4b is a schematic block diagram depicting an example broadcast communication from an access point to one or more additional access points.

FIG. 4c is a schematic block diagram depicting an example broadcast communication from an access point to one or more additional access points.

FIG. 4d is a schematic block diagram depicting an example broadcast communication from an access point to one or more additional access points.

FIG. 4e is a schematic block diagram depicting an example mobile device receiving broadcast communications from a plurality of access points.

FIG. 5 is a flow diagram depicting an example process for wireless access point synchronization.

FIG. 6 is a flow diagram depicting an example process for compensating for multipath delay in wireless access point synchronization.

FIG. 7 is a flow diagram depicting an example process for updating synchronization packets for wireless access point synchronization.

FIG. 8 is a schematic block diagram depicting an example wireless communication system including a plurality of computing platforms comprising one or more wireless access points and one or more mobile devices.

### DETAILED DESCRIPTION

As mentioned above, a position of a mobile device, such as a cellular telephone, may be estimated based on information gathered from various systems. One such system may comprise a wireless local access network (WLAN) communication system comprising a number of access points to support communications for a number of mobile devices. As also mentioned above, a position estimate for a mobile device may be obtained, for example, through trilateration based on timing parameters. In an aspect, an example timing parameter may comprise propagation delay for a signal broadcast from one or more wireless access points and a mobile device. In order to provide a desired level of accuracy, it may be desirable to synchronize clock circuits for wireless access points involved in mobile device position estimation to within a specified amount of error. In an aspect, wireless access point synchronization may comprise individual wireless access points broadcasting synchronization packets that may communicate timing reference indicators and other parameters to other wireless access points. Neighboring wireless access points may periodically and/or continually adjust local clock references, such as dock circuitry, based on timing reference indicators received from other neighboring wireless access points. Over a period of time, the neighboring wireless access points may become synchronized with one another to within a specified amount of error.

As mentioned below in connection with FIG. 2, mobile device position estimation may occur in indoor environments. In such environments, satellite positioning system (SPS) signals, such as GPS signals, may not be available. Wi-Fi positioning may take on increased importance due to increasing demand for indoor positioning. Some Wi-Fi positioning systems may utilize signal strength (RSSI) and/or round trip delay (RTT) measurements to determine ranges between transmitters and a mobile device. However, utilizing RSSI for range determination may be susceptible to increased error due, for example, to environmental and/or body signal power attenuation. For example, one or more was may exist between an access point and a mobile device, making it difficult to achieve adequately accurate positioning. Additionally, although RTT measurements are time-based, and thus share some characteristics with GPS-like positioning, RTT requires round trip, two way communication between an access point and a mobile device, thereby consuming access point bandwidth and thus limiting a number of mobile devices that can be supported at a given time.

In an aspect, example position estimation techniques described herein utilize one-way timing measurements for signals transmitted from an access point to a mobile device, similar in some respects to GPS positioning signals. To support such one-way timing measurements, access point synchronization may be performed at least in part by individual access points broadcasting tinning reference indicators to other neighboring access points. Individual access points may receive one or more broadcast signals from one or more other access points, and individual access points may adjust local timing functions based at least in part on timing reference indicators, such as time stamps, received in the broadcast signals. Example techniques for synchronizing wireless access points are described more fully below.

FIG. 1 is a schematic block diagram depicting an example trilateration technique for determining an initial estimated position for a mobile device 100. A wireless network 120 may provide voice or data communication for a number of wireless terminals including mobile device 100, for example, and may further support position estimation for the wireless terminals in addition to providing voice or data communication. Wireless network 120 may comprise any of a number of wireless network types, several examples of which are described below. Wireless network 120 for this example may comprise terrestrial-based wireless transmitters 132, 134, and 136 that provide communication for a number of mobile devices such as, for example, mobile device 100. For simplicity, only a few transmitters 132, 134, and 136 are depicted and one mobile device 100 is depicted in FIG. 1. Of course, other examples may include a smaller or greater number of transmitters, and the configuration of transmitters depicted in FIG. 1 is merely an example configuration.

In an aspect, mobile device 100 may obtain one or more measurements from one or more signals received from one or more of the terrestrial transmitters 132, 134, and 136. For example, mobile device 100 may gather propagation delay information for signals received from one or more of wireless transmitters 132, 134, and 136. Mobile device 100 may calculate an estimated position for mobile device 100 through trilateration based, at least in part, on timing reference indicators, such as time stamps, received in packets received from wireless transmitters 132, 134, and 136, and on propagation delay times for signals received at mobile device 100 from wireless transmitters 132, 134, and 136. Position estimation for mobile device 100 may be further based, a least in part, on known or reported locations of the wireless transmitters 132, 134, or 136.

In an aspect, to perform a trilateration position estimate for a mobile device, signals from three or more wireless transmitters may be received. One or more characteristics of the received signals may be measured or otherwise obtained, and the respective signal characteristics may be used to estimate a range, or distance, between the wireless transmitters. As mentioned previously, in an aspect, propagation delay may be calculated for signals received from wireless transmitters at a mobile device, and ranges from the mobile device to the wireless transmitters may be estimated.

For the present example, as depicted in FIG. 1, mobile device 100 may receive a transmission from access point 132, and based at least in part on a timing reference indicator provided in the transmission, a range “a” may be calculated. Similarly, a range “b” may be calculated between access point 134 and mobile device 100 based at least in part on a timing reference indicator provided in the transmission by access point 134, and a range “c” may be calculated access point 136 and mobile device 100 based at least in part on a timing reference indicator provided in the transmission by access point 136 received at mobile device 100. If the locations of access points 132, 134, and 136 are known, as is assumed for the present example, a trilateration operation using techniques known to those of ordinary skill in the art may be used to determine an intersection point of all of the arcs formed by the aforementioned measurements of ranges “a”, “b”, and “c”, and the intersection point may be designated an estimate of a position for mobile device 100. In an aspect, ranges “a”, “b”, and “c” may be referred to as “pseudo-ranges”, in that ranges “a” “b”, and “c” may comprise estimated ranges. For example, access points 132, 134, and 136 may be well-synchronized. However, mobile device 100 may not be synchronized with access points 132, 134, and 136, and some error may be introduced into range estimate calculations. For example, a clock for mobile device 100 may be early with respect to the access point's clocks. In an aspect, a time difference between the clocks of a mobile device and an access point may be estimated together with a position of the mobile device.

If positions of wireless transmitters 132, 134, and 136 are accurate, and if respective calculations of ranges “a”, “b”, and “c” are accurate, an accurate position estimate may be obtained for mobile device 100. However, inaccuracies in the calculated ranges “a”, “b” or “c” may result in an inaccurate position estimation. Accurate range calculations may be obtained, at least in part, through accurate timing reference indicators provided by wireless transmitters 132, 134, and 126. Also, in an aspect, accurate timing reference indicators, for example within a specified amount of error, may be promoted at least in part through synchronization of wireless transmitters 132, 134, and 136.

FIG. 2 is a schematic block diagram depicting an example partial floor plan 210 of an interior of one floor of an example office building. Of course, floor plan of 210 is merely an example, and the scope of claimed subject matter is not limited to any particular floor plan, building type, or building size. For the particular example of FIG. 2, partial floor plan 200 comprises three wireless access points 232, 234, and 236. Although the example depicted in FIG. 2 utilizes three access points, the scope of claimed subject matter is not limited in this respect, and other example implementations may utilize any number of access points. Further, the configuration of access points 232, 234, and 236 depicted in FIG. 2 is merely an example configuration, and again the scope of claimed subject matter is not limited in this respect.

As discussed above in connection with FIG. 1, one example technique for determining a position estimate for a mobile device involves trilateration using range measurements to three or more wireless transmitters. As also discussed above, techniques for estimating a position for a mobile device may exhibit inaccuracies introduced at least in part by timing synchronization errors among the access points, for example. Accuracy for mobile station position estimation in an indoor situation may be particularly desirable in the absence of satellite positioning system (SPS) navigation signals. Additionally, as mentioned above, indoor mobile device positioning utilizing RSSI and RTT may be problematic. In an aspect, wireless access points 232, 234, and 236 may individually broadcast synchronization packets to the other access points in order to provide the other access points with timing reference indicators with which individual access points may adjust local timing functions to more closely synchronize with the other access points. Example techniques for synchronizing wireless access points are discussed in more detail below.

As used herein, the term “access point” is meant to include any wireless communication station and/or device used to facilitate communication in a wireless communications system, such as, for example, a wireless local area network, although the scope of claimed subject matter is not limited in this respect. Also, as used herein, the terms “access point” and “wireless transmitter” may be used herein interchangeably. In another aspect, an access point may comprise a wireless local area network (WLAN) access point, for example. Such a WLAN may comprise a network compatible and/or compliant with one or more versions of IEEE standard 802.11 in an aspect, although the scope of claimed subject matter is not limited in this respect. A WLAN access point may provide communication between one or more mobile devices and a network such as the Internet, for example.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

Returning once more to FIG. 2, for the present example, the communication system may comprise a wireless system compliant to and/or compatible with one or more versions of IEEE standard 802.11x. Further example wireless communication systems are mentioned below, and the scope of claimed subject matter is not limited to any particular wireless network type.

FIG. 3 is a flow diagram of an example technique for mobile device position estimation. At block 310, clock timing among a number of access points may be synchronized. Example techniques for synchronizing access points are discussed in more detail, below. At block 320, beacon signal comprising time references may be received at a mobile device from a number of access points. Also, in an aspect, at block 330, ranges from the mobile device to the various access points may be determined, and at block 340 a trilateration operation may be performed to determine a position estimate for the mobile device. Of course, claimed subject matter is not limited to the specific examples described herein. For example, embodiments may comprise more than or less than blocks 310-340. Also, the order of blocks 310-340 is merely an example order.

FIGS. 4a-4d collectively depict example broadcast communications from individual wireless access points to other wireless access points in order to share timing reference indicators. Using the timing reference indicators received from one or more other wireless access points, individual access points may adjust a local timing function to more closely synchronize with the one or more other access points.

For example, FIG. 4a is a schematic block diagram depicting an example broadcast communication from an access point 402 to one or more additional access points 406, 404, and/or 408. For the example depicted in FIG. 4a, access point 402 may broadcast a synchronization packet 422, and access points 406, 404, and/or 408 may receive synchronization packet 422. FIG. 4b depicts access point 402 broadcasting a synchronization packet 426 to access points 402, 404, and/or 408, FIG. 4c depicts access point 408 broadcasting a synchronization packet 428 to access points 402, 406, and/or 404, and FIG. 4d depicts access point 404 broadcasting a synchronization packet 424 to access points 402, 406, and/or 408. In an aspect, access points 402, 404, 406, and 408 may broadcast their respective synchronization packets according to a schedule. For example, a synchronization packet may include a next transmission time, thereby providing neighboring access points with this information so that the neighboring access points can schedule their synchronization packets in a manners that they do not collide with synchronization packets from other access points. In another example, a number of time slots may be defined, and individual access points may select a particular time slot in which to broadcast synchronization packets. In a further example, access points may broadcast synchronization packets in a random fashion, which may have a benefit of avoiding complexity of coordination with other access points. Additionally, in an aspect, access points 402, 404, 406, and 408 may continually and/or periodically broadcast synchronization packets, and claimed subject matter is not limited in scope in these respects.

Additionally, in an aspect, synchronization packets may be broadcast by an access point in a burst pattern. Repeating a transmission of an identical synchronization packet may provide an improved signal-to-noise ratio for received packets, and may also provide improved timing accuracy. Improved timing accuracy may be due at least in part to an averaging of time stamp errors among the packets of a burst of packets. In an aspect, a synchronization packet may be transmitted multiple times within an individual time slot. For example, if a scheduled time slot for synchronization packet transmission is 100 ms, a number of 5 ms synchronization packets may be broadcast within the 100 ms window.

FIG. 4e is a schematic block diagram depicting an example mobile device 405 receiving broadcast communications from a plurality of access points, 402, 404, 406, and 408. In an aspect, utilizing example techniques described herein, access points 402, 404, 406, and/or 408 may be synchronized to within a specified amount of error, thereby providing mobile device 405 with timing adequately accurate timing to support position estimation operations. Note that access points 402, 404, 406, and 408 utilize broadcast communications 422, 424, 426, and 428 for synchronization purposes, and that mobile device 405 utilizes broadcast communications 422, 424, 426, and 428 for position estimation purposes.

For the example depicted in FIGS. 4a-4e, it may be noted that communication between access points 402, 404, 406, and/or 408 and mobile device 405 occurs in a one-way fashion, similar in some respects to how timing signals are provided in GPS positioning systems. In this manner, any number of mobile devices may be supported, which is an improvement over systems that utilize two-way communication between access points and mobile devices.

FIG. 5 is a flow diagram depicting an example process for wireless access point synchronization. At block 510, a first one-way synchronization message may be received at a first access point positioned at a first location from second access point positioned at a second location. In an aspect, the synchronization message may include a first time reference indicator from the second access point. At block 520, a time delay between a local time reference for the first access point and the first time reference indicator from the second access point may be computed. The local time reference may be adjusted based at least in part on the computed time delay and on a range between the first and second access points at block 530.

At block 540, a second one-way synchronization message including an indication of the adjusted time reference may be transmitted to one or more access points, including the second access point. In an aspect, the receive, compute, adjust, and transmit operations depicted at blocks 510, 520, 530, and 540 may be repeated. For example, the receive, compute, adjust, and transmit operations may be repeated periodically and/or continually. In this manner, individual access points may synchronize their respective local time references based at least in part on timing reference indicators received from other neighboring access points. Of course, examples may include all of blocks 510-540, more than blocks 510-540, or less than blocks 510-540. Additionally, the order of blocks 510-540 is merely an example order, and claimed subject matter is not limited in scope in this respect.

Table 1, below, depicts example elements of an example synchronization packet.

TABLE 1
Broadcast Synchronization Packet

| Item | Description |
|---|---|
| posLLA | Position in latitude, longitude, altitude of a respective access |
| | point. |
| tTX | Time of transmission of the packet |
| tUnc | Uncertainty of time stamp |
| tRefSrc | Source of timing reference |
| | 0: low/medium quality internal clock w. relative timing |
| | 1: high quality internal clock (e.g. OCXO) w. relative timing |
| | 2: low/medium quality external timing reference (e.g. NTP) w. |
| | absolute timing |
| | 3: high quality external timing reference (e.g. IEEE1588) w. |
| | absolute timing |
| | 4: GPS (or GNSS) |
| | 5: other wireless external reference |
| | Other values are reserved |

Neighbor list (following fields may be repeated per neighbor access point)

| | |
|---|---|
| apMAC | MAC address of a neighboring access point |
| posLLA | Position of the neighboring access point |
| DistEst | Estimated distance to the neighboring access point |
| TAEst | Estimated time advance of the access point over the |
| | neighboring access point including multipath delay |
| MPEst | Estimated multipath delay to the respective access point from |
| | the neighboring access point |

In an aspect, access points may comprise timing circuitry that may vary in accuracy from one access point to another. For example, an access point may comprise a relatively high quality internal timing reference such as an oven-controlled crystal oscillator (OCXO). Examples of low/medium quality clock circuitry for an internal timing reference for an access point may comprise a crystal oscillator (XO) or a temperature controlled crystal oscillator (TCXO). Access points may also utilize GPS, NTP, or IEEE1588 timing references, to name several other examples. In an aspect, an access point utilizing a relatively high quality timing reference, such as, for example, OCXO, network time protocol (NTP), or precision time protocol (PTP, IEEE1588), may indicate a relatively small value for a timing reference uncertainty parameter (tUnc) in broadcast synchronization packets, indicating less uncertainty with respect to the timing reference. Also, in an aspect, a timing reference source field tRefSrc for individual access points may be provided in broadcast synchronization packets, as shown in Table 1, for example.

Further, in an aspect, access points that incorporate more accurate timing references may be utilized as timing anchors for neighboring access points that may utilize less accurate timing references. For example, an access point with a lower accuracy timing reference may give more weight to synchronization packets received from access points that indicate higher accuracy timing references. In this manner, an access point having a lower quality timing reference may eventually follow the timing of one or more other access points utilizing more accurate timing references.

In an aspect, a synchronization packet may include both fixed portions and variable portions. For example, a variable portion may comprise time varying information, such as tTX and/or TAEst in order to provide up-to-date information. Also, in an aspect, a fixed portion may be utilized to improve reception sensitivity and/or timing measurement accuracy. For example, a pseudorandom sequence known to other access points and/or mobile devices may be included in all synchronization packets. Additionally, a synchronization packet may include additional information, such as an access point's own transmission power characteristics and/or path loss to neighboring access points to provide further description of the radio frequency (RF) channel characteristics. Further, in an aspect, RF characteristics may be utilized for predicting timing measurement accuracy, for example.

Although specific elements are depicted in Table 1 for a synchronization packet, claimed subject matter is not limited to the specific elements depicted. For example, a subset of depicted elements may be provided, or a superset. In an aspect, the position of the neighboring access point may not be provided in the synchronization packet, for example. An estimated time advance may also not be provided, in an aspect, for example.

FIG. 6 is a flow diagram depicting an example process for compensating for multipath delay in wireless access point synchronization. By compensating for multipath delay during the synchronization process, multipath error in position estimation operations for mobile devices may by improved, for example. In an aspect, MPEst in a synchronization packet may be utilized in any of several ways by a mobile device. For example, if MPEst is relatively high, a mobile device may predict that its own position estimate may be low in accuracy. In another example, a mobile device may utilize an MPEst distribution among access points to weight range estimates for individual access points. For example, given that a first access point has MPEst of 100 ns, 200 ns, 300 ns to its neighbors, and given that a second access point has MPEst of 10 ns, 20 ns, and 30 ns to its neighbors, it may follow that the second access point tends to experience less multipath error. Thus, for this example, a mobile device may trust range measurements from the second access point more than range measurements from the first access point.

For the example process depicted in FIG. 6, a time of arrival measurement may be performed for a synchronization packet received at an access point, as depicted at block 610. In an aspect, an access point may receive synchronization packets from multiple other access points. For example, time of arrival measurements may be represented as

T(i,j)=tRX(i,j)−tTX(i) (1)

where tTX(i) represents a time of transmission indicated in a synchronization packet received from an ith access point and where tRX(i,j) represents a time of arrival when a synchronization packet is received at the jth access point. Additionally, T(i,j) represents a tune of flight, or propagation delay, between the ith access point and the jth access point.

At block 620, synchronization packets may be decoded at one or more access points to obtain time of transmission and/or other timing parameters. In an additional aspect, relative time offset between the time of arrival and the time of transmission may be estimated, as depicted at block 630. Relative time offsets may comprise, for example, amounts of time by which to advance or delay local clocks at one or more access points. In an aspect, relative time offsets may be estimated at least in part in response to collecting synchronization packets from multiple neighboring access points. Also, in an aspect, relative time offsets may be estimated based at least in part on a weighted sum of measurements from neighboring access points. Measurements may be weighted, for example, based on time uncertainty indications. In an aspect, time uncertainty may be represented as tUnc. In another aspect, measurements with larger deviations for tUnc may be removed from time offset estimation calculations.

In an example, time offset estimation may be represented as

TAEst(j)=sum((T(i,j)−distEst(i,j)/c−(MPEst(i,j)+MPEst(j,i))/2)*w(i)) (2)

where TAEst(j) represents an estimated time advance for a jth access point over neighboring access points. Additionally, sum( ) represents a summation function, adding up enclosed values for all ith access points representing neighboring access points whose synchronization packets are received by the jth access point. Further, w(i) represents a weight value for the ith access point. In an aspect, w(i) may be calculated, for example, using the following expression:

w(i)=(1/tUnc(i)²)/sum(1/tUnc(i)²) (3)

Additionally, referring again to expression (2), distEst(i,j) represents a range estimate between an ith access point and the jth access point. In an aspect, the range estimate may be based in part on positions of the ith and jth access points, which may be represented as posLLA(i) and posLLA(j). Also, in an aspect, posLLA(i), for example, may comprise a position for the ith access point indicated by longitude, latitude, and altitude coordinates. Other coordinate systems may also be utilized, of course. Further, as indicated in expression (2), range estimate distEst(i,j) is divided by the speed of light, represented as c, to convert the range estimate to a time measurement. Also, in expression (2), MPEst(j,i) represents a multipath delay estimate previously estimated by the ith access point and provided in a received synchronization packet, while MPEst(i,j) represents a multipath delay estimate previously estimated by the jth access point for the path between the ith access point and the jth access point. In an aspect, if multipath delay has not been previously estimated, MPEst(j,i) and MPEst(i,j) may be set to zero or to a nominal or specified multipath delay value for a given environment. Further, as mentioned, tUnc(i) represents a time uncertainty for the ith access point provided in a received synchronization packet.

Block 640 indicates that a smoothing filter may be applied to time offset estimates. For example, a Kalman filter may be applied to TAEst(j). Also, in an aspect, as depicted at block 650, multipath delay may be estimated for neighboring access points. For example, TAest may be obtained for individual neighboring access points according to expression (3) as follows:

TAEst(i,j)=T(i,j)−distEst(i,j)/c−TAEst(j) (3)

In an aspect, multipath delay estimate, MPEst(i,j), may be obtained by leveraging TAEst(i,j) and TAEst(j) provided in a received synchronization packet according to expression (4) as follows:

MPEst(i,j)=(TAEst(i,j)+TAEst(j,i))/2 (4)

A smoothing filter, such as a Kalman filter, for example, may be applied to estimated parameters at block 660. In an example, a smoothing filter may be applied to parameters distEst(i,j), TAEst(i,j), and/or MPEst(i,j).

Further, in an aspect, an internal clock for the access point may be adjusted, as depicted at block 670, to compensate for a relative time difference between an access point and neighboring access points. In an aspect, an internal clock of a jth access point may be adjusted by an amount represented by TAEst(j). For example, a clock for the jth access point may be running faster than the neighboring access point's clock by TAEst(j), and an adjustment may be made to slow the dock for the jth access point. Of course, examples may include all of blocks 610-670, more than blocks 610-670, or less than blocks 610-670. Additionally, the order of blocks 610-670 is merely an example order, and claimed subject matter is not limited in scope in this respect.

FIG. 7 is a flow diagram depicting an example process for updating synchronization packets for wireless access point synchronization. As depicted at block 710, a determination may be made as to whether a change in one or more synchronization packet parameters exceeds a specified threshold. Also, as depicted at block 710, if the change to the one or more synchronization packet parameters does not exceed the threshold, processing may continue at block 730 where a synchronization packet may be broadcast. As further depicted at block 710 and at block 720, synchronization packets may be updated for access points with changes determined to exceed the specified threshold. In an aspect, the threshold may be specified as 1% of a previous value, for example, although claimed subject matter is not limited in scope in this respect. At least in part in response to updating the synchronization packets, the synchronization packets may be broadcast by their respective access points, as depicted at block 730. Additionally, in an aspect, some contents of synchronization packets may be updated automatically for broadcast. In an aspect, threshold checking may apply to contents that may not automatically change over time. For example, TAEst and/or MPEst may not change much, or may change not at all, once neighboring access points are synchronized. Examples may include all of blocks 710-730, more than blocks 710-730, or less than blocks 710-730. Additionally, the order of blocks 710-730 is merely an example order.

FIG. 8 is a schematic diagram illustrating an example system 800 that may include one or more devices configurable to implement techniques or processes described above, for example, in connection with FIGS. 1-7, System 800 may include, for example, a first device 802, a second device 804, and a third device 806, which may be operatively coupled together through a wireless communications network 808. In an aspect, first device 802 may comprise an access point, for example. Second and third devices 804 and 806 may comprise mobile devices, in an aspect. Also, in an aspect, wireless communications network 808 may comprise one or more wireless access points, for example. However, claimed subject matter is not limited in scope in these respects.

First device 802, second device 804 and third device 806, as shown in FIG. 8, may be representative of any device, appliance or machine that may be configurable to exchange data over wireless communications network 808. By way of example but not limitation, any of first device 802, second device 804, or third device 806 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 802, 804, and 806, respectively, may comprise one or more of an access point or a mobile device in accordance with the examples described herein.

Similarly, wireless communications network 808, as shown in FIG. 8, is representative of one or more communication links, processes, or resources configurable to support the exchange of data between at least two of first device 802, second device 804, and third device 806. By way of example but not limitation, wireless communications network 808 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 806, there may be additional like devices operatively coupled to wireless communications network 808.

It is recognized that all or part of the various devices and networks shown in system 800, and the processes and methods as further described herein, may be implemented using or otherwise including hardware, firmware, software, or any combination thereof.

Thus, by way of example but not limitation, second device 804 may include at least one processing unit 820 that is operatively coupled to a memory 822 through a bus 828.

Processing unit 820 is representative of one or more circuits configurable to perform at least a portion of a data computing procedure or process. By way of example but not limitation, processing unit 820 may include one or more processors, controllers, microprocessors, microcontrollers, application specific integrated circuits, digital signal processors, programmable logic devices, field programmable gate arrays, and the like, or any combination thereof.

Memory 822 is representative of any data storage mechanism. Memory 822 may include, for example, a primary memory 824 or a secondary memory 826. Primary memory 824 may include, for example, a random access memory, read only memory, etc. While illustrated in this example as being separate from processing unit 820, it should be understood that all or part of primary memory 824 may be provided within or otherwise co-located/coupled with processing unit 820.

Secondary memory 826 may include, for example, the same or similar type of memory as primary memory or one or more data storage devices or systems, such as, for example, a disk drive, an optical disc drive, a tape drive, a solid state memory drive, etc. In certain implementations, secondary memory 826 may be operatively receptive of, or otherwise configurable to couple to, a computer-readable medium 840. Computer-readable medium 840 may include, for example, any non-transitory medium that can carry or make accessible data, code or instructions for one or more of the devices in system 800. Computer-readable medium 840 may also be referred to as a storage medium.

Second device 804 may include, for example, a communication interface 830 that provides for or otherwise supports the operative coupling of second device 804 to at least wireless communications network 808. By way of example but not limitation, communication interface 830 may include a network interface device or card, a modem, a router, a switch, a transceiver, and the like.

Second device 804 may include, for example, an input/output device 832. Input/output device 832 is representative of one or more devices or features that may be configurable to accept or otherwise introduce human or machine inputs, or one or more devices or features that may be configurable to deliver or otherwise provide for human or machine outputs. By way of example but not limitation, input/output device 832 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (MAN), a wireless personal area network (WPAN), and so on. The term “network” and “system” may be used interchangeably herein. A WWAN may be a Code Division Multiple Access (COMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2), 3GPP and 3GPP2 documents are publicly available. 4G Long Term Evolution (LTE) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method, comprising, at a first access point positioned at a first location:
receiving a first one-way synchronization message comprising a first time reference indicator from a second access point positioned at a second location;
computing a time delay between a local time reference for the first access point and the first time reference indicator;
adjusting the local time reference based at least in part on the computed time delay and based at least in part on a range between the first access point and the second access point; and
transmitting a second one-way synchronization message comprising an indication of the adjusted local time reference to one or more access points, including the second access point.

2. The method of 1, wherein the first location and the second location are known, and wherein the range between the first access point and the second access point is calculated based at least in part on the first and second known locations.

3. The method of claim 1, wherein the first one-way synchronization message comprises an indication of the second location.

4. The method of claim 3, further comprising calculating the range between the first access point and the second access point based at least in part on the indication of the second location received with the first one-way synchronization message.

5. The method of claim 3, wherein the first one-way synchronization message further comprises an indication of one or more neighbor access points, and wherein said transmitting the second one-way synchronization message to one or more access points comprises transmitting the second one-way synchronization message to the one or more neighbor access points.

6. The method of claim 1, wherein said adjusting the local time reference comprises compensating the local time reference to account for multipath delay experienced by the first one-way synchronization message received at the first access point.

7. The method of claim 6, wherein said compensating the local time reference to account for multipath delay comprises compensating the local time reference based at least in part on a value indicating an estimated time advance for the second access point over one or more neighbor access points and a value indicating an estimated multipath delay between the second access point and one or more neighbor access points received at the first access point as part of the first one-way synchronization message.

8. The method of claim 1, further comprising broadcasting at least a one-way ranging message including the indication of the adjusted local time reference to a mobile device for use by the mobile device in measuring a range from the first access point to the mobile device.

9. The method of claim 1, further comprising repeating said receiving, said computing, said adjusting, and said transmitting in a substantially periodic and continuous manner.

10. The method of claim 9, wherein said first one-way synchronization schedule further comprises an indication of a synchronization message broadcast schedule, and wherein said repeating said receiving and said transmitting comprises repeating said receiving and said transmitting according to the broadcast schedule.

11. An article, comprising: a storage medium having stored thereon instructions executable by a processor of a first access point positioned at a first location to:
obtain a first one-way synchronization message comprising a first time reference indicator from a second access point positioned at a second location;
calculate a time delay between a local time reference for the first access point and the first time reference indicator;
adjust the local time reference based at least in part on the computed time delay and based at least in part on a range between the first access point and the second access point; and
initiate transmission of a second one-way synchronization message comprising an indication of the adjusted local time reference to one or more access points, including the second access point.

12. The article of 11, wherein the first location and the second location are known, and wherein the range between the first access point and the second access point is calculated based at least in part on the first and second known locations.

13. The article of claim 11, wherein the first one-way synchronization message comprises an indication of the second location.

14. The article of claim 13, wherein the storage medium has stored thereon further instructions executable by the processor of the first access point to calculate the range between the first access point and the second access point based at least in part on the indication of the second location received with the first one-way synchronization message.

15. The article of claim 13, wherein the first one-way synchronization message further comprises an indication of one or more neighbor access points, and wherein the storage medium has stored thereon further instructions executable by the processor of the first access point to initiate transmission of the second one-way synchronization message to one or more access points at least in part by initiating transmission of the second one-way synchronization message to the one or more neighbor access points.

16. The article of claim 11, wherein the storage medium has stored thereon further instructions executable by the processor of the first access point to adjust the local time reference at least in part by compensating the local time reference to account for multipath delay experienced by the first one-way synchronization message received at the first access point.

17. The article of claim 16, wherein the storage medium has shared thereon further instructions executable by the processor of the first access point to compensate the local time reference to account for multipath delay at least in part by compensating the local time reference based at least in part on a value indicating an estimated time advance for the second access point over one or more neighbor access points and a value indicating an estimated multipath delay between the second access point and one or more neighbor access points received at the first access point as part of the first one-way synchronization message.

18. The article of claim 11, wherein the storage medium has stored thereon further instructions executable by the processor of the first access point to initiate broadcasting of at least a one-way ranging message including the indication of the adjusted local time reference to a mobile device for use by the mobile device in measuring a range from the first access point to the mobile device.

19. The article of claim 11, wherein the storage medium has stored thereon further instructions executable by the processor of the first access point to repeat said obtaining, said computing, said adjusting, and said initiating transmission in a substantially periodic and continuous manner.

20. The method of claim 19, wherein said first one-way synchronization schedule further comprises an indication of a synchronization message broadcast schedule, and wherein the storage medium has stored thereon further instructions executable by the processor of the first access point to repeat said obtaining and said initiating transmission at least in part by repeating said obtaining and said initiating transmission according to the broadcast schedule.

21. An apparatus, comprising: a first access point positioned at a first location, comprising:
a communication interface to receive a first one-way synchronization message comprising a first time reference indicator from a second access point positioned at a second location; and
a processor to calculate a time delay between a local time reference for the first access point and the first time reference indicator, the processor further to adjust the local time reference based at least in part on the computed time delay and based at least in part on a range between the first access point and the second access point, the communication interface further to transmit a second one-way synchronization message comprising an indication of the adjusted local time reference to one or more access points, including the second access point.

22. The apparatus of 21, wherein the first location and the second location are known, and wherein the range between the first access point and the second access point is calculated based at least in part on the first and second known locations.

23. The apparatus of claim 21, wherein the first one-way synchronization message comprises an indication of the second location.

24. The apparatus of claim 23, the processor to calculate the range between the first access point and the second access point based at least in part on the indication of the second location received with the first one-way synchronization message.

25. The apparatus of claim 23, wherein the first one-way synchronization message further comprises an indication of one or more neighbor access points, communication interface to transmit the second one-way synchronization message to one or more access points at least in part by transmitting the second one-way synchronization message to the one or more neighbor access points.

26. The apparatus of claim 21, the processor to adjust the local time reference at least in part by compensating the local time reference to account for multipath delay experienced by the first one-way synchronization message received at the first access point.

27. The apparatus of claim 26, the processor to compensate the local time reference to account for multipath delay at least in part by compensating the local time reference based at least in part on a value indicating an estimated time advance for the second access point over one or more neighbor access points and a value indicating an estimated multipath delay between the second access point and one or more neighbor access points received at the first access point as part of the first one-way synchronization message.

28. The apparatus of claim 21, the communication interface further to broadcast at least a one-way ranging message including the indication of the adjusted local time reference to a mobile device for use by the mobile device in measuring a range from the first access point to the mobile device.

29. The apparatus of claim 21, the first access point to repeat said receiving, said computing, said adjusting, and said transmitting in a substantially periodic and continuous manner.

30. The apparatus of claim 29, wherein said first one-way synchronization schedule further comprises an indication of a synchronization message broadcast schedule, the first access point to repeat said receiving and said transmitting at least in by repeating said receiving and said transmitting according to the broadcast schedule.

31. An apparatus, comprising:
means for receiving at a first access point positioned at a first location a first one-way synchronization message comprising a first time reference indicator from a second access point positioned at a second location;
means for computing a time delay between a local time reference for the first access point and the first time reference indicator;
means for adjusting the local time reference based at least in part on the computed time delay and based at least in part on a range between the first access point and the second access point; and
means for transmitting a second one-way synchronization message comprising an indication of the adjusted local time reference to one or more access points, including the second access point.

32. The apparatus of 31, wherein the first location and the second location are known, and wherein the range between the first access point and the second access point is calculated based at least in part on the first and second known locations.

33. The apparatus of claim 32, wherein the first one-way synchronization message comprises an indication of the second location.

34. The apparatus of claim 33, further comprising means for calculating the range between the first access point and the second access point based at least in part on the indication of the second location received with the first one-way synchronization message.

35. The apparatus of claim 33, wherein the first one-way synchronization message further comprises an indication of one or more neighbor access points, and wherein said means for transmitting the second one-way synchronization message to one or more access points comprises means for transmitting the second one-way synchronization message to the one or more neighbor access points.

36. The apparatus of claim 31, wherein said means for adjusting the local time reference comprises means for compensating the local time reference to account for multipath delay experienced by the first one-way synchronization message received at the first access point.

37. The apparatus of claim 36, wherein said means for compensating the local time reference to account for multipath delay comprises means for compensating the local time reference based at least in part on a value indicating an estimated time advance for the second access point over one or more neighbor access points and a value indicating an estimated multipath delay between the second access point and one or more neighbor access points received at the first access point as part of the first one-way synchronization message.

38. The apparatus of claim 31, further comprising means for broadcasting at least a one-way ranging message including the indication of the adjusted local time reference to a mobile device for use by the mobile device in measuring a range from the first access point to the mobile device.

39. The apparatus of claim 31, further comprising means for repeating said receiving, said computing, said adjusting, and said transmitting in a substantially periodic and continuous manner.

40. The apparatus of claim 39, wherein said first one-way synchronization schedule further comprises an indication of a synchronization message broadcast schedule, and wherein said means for repeating comprises means for repeating said receiving and said transmitting according to the broadcast schedule.
